(19) United States
(12) Patent Application Publication
(10) Pub. No.: US 2003/0003868 A1
(43) Pub. Date: Jan. 2, 2003

(54) Method and system for short-range radio communication

(76) Inventor: Ilkka Juurikko, Tampere (FI)

Correspondence Address: MORGAN & FINNEGAN, L.L.P., 345 Park Avenue, New York, NY, 10154-0053, US

(21) Appl. No.: 10/117,593

(22) Filed: Apr. 5, 2002

(30) Foreign Application Priority Data
Jun. 29, 2001 (FI) 20011419

(51) Int. Cl. H04B 5/00

(52) U.S. Cl. 455/41; 455/414; 455/422

(57) ABSTRACT

A method and a system for a short-range communication system. The method comprises advising a short-range terminal (104, 109) of a change in the quality of a connection by the initiative of a short-range rf access point (101 to 103). In the method, a short-range connection is established between said terminal (104, 109) and said access point (101 to 103), said access point (101 to 103) monitors the level of the signal transmitted by said terminal (104, 109), said access point (101 to 103) compares the strength of the radio-frequency signal transmitted by said terminal (104, 109) with a predetermined threshold value. In the method, said access point (101 to 103) also forms information about a change in the quality of said connection to be presented in said terminal (104, 109) if said signal strength falls below said threshold value, the information comprising an item about a change in the quality of the connection.

The present invention relates to the use of short-range radio frequency technology. Particularly, but not necessarily, the invention relates to guiding a user of a wireless terminal employing Bluetooth technology in determining a service area.

### FIELD OF THE INVENTION

Bluetooth technology is a new technology, which is employed in wireless communication and enables communication of mobile telephones, computers, PDA (Personal Digital Assistant) devices or generally devices with an integrated Bluetooth circuit, by using a short-range wireless radio connection. Each device supporting the Bluetooth technology, i.e. a Bluetooth device, is provided with a Bluetooth transceiver. For example, it can be a microchip, an integrated circuit, which transmits and receives information, such as speech or data, wirelessly within a frequency range of about 2.4 GHz. Currently, the range of a Bluetooth connection is about 10 meters, when normal transmission power is used.

### BACKGROUND OF THE INVENTION

Short-range radio devices allow creation of various systems and services in offices, shopping malls or public premises, for instance, by utilizing access points. The services thus operate only in the vicinity of the access point, typically within the range of only about 10 meters. Hence, a problem arises that the service area of this kind of service is not apparent to a user. Thus, the service user is not aware of being on the fringe of the service area, unless he or she is not informed about it in one way or another, and consequently the connection may be suddenly disconnected. The user should therefore be aware of the changes in his/her connection so as to be able to choose whether to stay in the Bluetooth Access Point (BAP) area or to release the current connection.

U.S. Pat. No. 5,373,548 discloses a prior art solution that provides an out-of-range warning. The operational environment is a cordless telephone, in which a connection between a handset of said telephone and a base unit to be connected to a telephone network, i.e. a base station part, is established by a radio connection. The base unit measures an RF signal received from the handset and produces a warning tone in a handset earpiece of said telephone if the RF signal level is below a minimum threshold value that is necessary for maintaining the connection between the base station unit and the handset part. Said warning signal is implemented such that despite the handset part is beyond the normal operating area of the cordless telephone the user of said handset part is able to hear said warning signal. The base station unit transmits a predetermined number of warning signals and if the handset part does not return to the operating area of the base station unit, the base station unit is disconnected from the telephone network.

It is obvious to a person skilled in the art that the operating range of said cordless telephones is several hundreds of meters in a space without obstacles and several tens of meters even indoors. Thus, in the case of an average user, the handset relatively seldom gets beyond the operating range. In addition, a problem with the above-described solution is that the warning is only given in the form of a warning tone. A subdued or high-frequency warning tone may remain unheard, for instance, if the user has greater difficulties than what is normal in hearing sounds. A loud warning tone, in turn, may be unpleasant to the user. In the cordless telephone described in the above publication it is an obvious way to give the warning to the user in the form of sound, because the use of the cordless telephone is restricted to speech only, and typically it does not comprise a display where the user would receive visual information. Moreover, in a noisy environment the user does not necessarily hear the sound and therefore it is advantageous to have also other types of out-of-range warnings, as will appear when the invention is described in greater detail.

### SUMMARY OF THE INVENTION

A method and a system are now invented for short-range radio communication, in which method a short-range rf access point monitors signal strengths of terminals within its area. When the signal coming from the terminal is so weak that it can be assumed to be at the extreme end of its range (threshold value), said short-range rf access point informs it about the situation. The information transmitted by the access point is advantageously visual information on the display of the terminal and/or speech information, such as synthesized speech in the loudspeaker of the terminal. A warning message appearing on the display is particularly useful in a noisy environment or when the user typically watches the display (netsurfing or general data transmission).

The user of the terminal remains aware of the extreme limits of the connection used and of the possibility to maintain the connection before its maintenance becomes impossible due to the range. It is a useful operation to guide the user of the terminal, because the user does not necessarily know the location of the access point when moving about for the first time in an area unknown to him. In the above-described prior art publication, this is not done, and need not be done, because, in general, the user of the handset is aware of the location of the base station unit.

A first aspect of the invention implements a method for an access point advising a terminal of a change in the quality of a short-range radio connection between the terminal and the access point, which method comprises establishing a short-range radio connection between said terminal and said access point, monitoring, by said access point, the strength of a radio-frequency signal transmitted by said terminal, comparing, by said access point, the strength of the radio-frequency signal transmitted by said terminal with a predetermined threshold value, characterized by transmitting a message to the terminal by said access point if said signal strength is below said predetermined threshold value, the message comprising information on said connection quality change to be presented in said terminal, the information being at least one of the following: visual information and speech information.

A second aspect of the invention implements a system for advising of a change in the quality of a short-range radio-frequency connection between a terminal and an access point, the system comprising at least one terminal (104, 109) and at least one access point (101 to 103), said terminal (104, 109) being able to communicate on the short-range radio connection with said access point (101 to 103), the system comprises connection establishment means for establishing a connection between said terminal and said access point, monitoring means for monitoring the level of a signal transmitted by said terminal, comparison means for comparing the strength of the radio-frequency signal transmitted by said terminal with a predetermined threshold value, characterized in that the system additionally comprises formation means for forming information to the terminal in response to the detected change in the quality of the connection, transmission means for said access point transmitting a message to said terminal if said signal strength is below said predetermined threshold value, the message comprising information on the change in the quality of said connection to be presented in said terminal, the information being at least one of the following: visual information and speech information.

A third aspect of the invention implements an electronic device, which is able to communicate in a short-range communication system, the device comprising connection establishment means for establishing a connection with a short-range terminal, characterized in that the device further comprises reception means for receiving the signal strength of said terminal, comparison means for comparing said signal strength with a predetermined threshold value and transmission means for transmitting information to the terminal in response to the performed comparison, the information comprising an item about a change in the quality of the connection and being at least one of the following: visual information and speech information.

A fourth aspect of the invention implements a short-range terminal which is able to communicate in a short-range communication system, the terminal comprising means for establishing a connection with a short-range rf access point, characterized in that the device also comprises transmission means for transmitting the signal strength of said terminal to said access point, reception means for receiving information from said access point in response to the transmitted signal, the information comprising an item on the change in the quality of the connection and being at least one of the following: visual information and speech information.

A fifth aspect of the invention implements a computer software product for a short-range rf access point, the access point being able to communicate in a short-range communication network at least with one short-range terminal, and the computer software product comprises computer software means for establishing a connection between said access point and the short-range terminal, characterized in that the computer software product comprises computer software means for making said access point receive the signal of said terminal, computer software means for making said access point compare the strength of said signal with a predetermined threshold value and computer software means for making said access point transmit information to the terminal in response to the performed comparison, the information comprising an item about a change in the quality of the connection and being at least one of the following: visual information and speech information.

A sixth aspect of the invention implements a computer software product for a short-range terminal, the terminal being able to communicate in a short-range communication network with at least one short-range rf access point, and the computer software product comprises computer software means for making said terminal establish a connection with the short-range rf access point, characterized in that the computer software product comprises computer software means for making said terminal transmit a radio-frequency signal to said access point, computer software means for making said terminal receive information from said access point in response to the transmitted signal, the information comprising an item about a change in the quality of the connection and being at least one of the following: visual information and speech information.

### BRIEF DESCRIPTION OF THE DRAWINGS

In the following, the invention will be described in greater detail with reference to the attached drawings, wherein

FIG. 1a shows a short-range radio system according to the invention;

FIG. 1b shows an alternative message according to an embodiment of the invention for guiding a user in defining the service area;

FIG. 2 is a flow chart of a method according to an embodiment of the invention at an access point;

FIG. 3 is a flow chart of a method according to an embodiment of the invention in a terminal;

FIG. 4 shows an embodiment of a terminal to be used in a short-range radio system; and

FIG. 5 shows an embodiment of an access point to be used in a short-range radio system.

### DETAILED DESCRIPTION

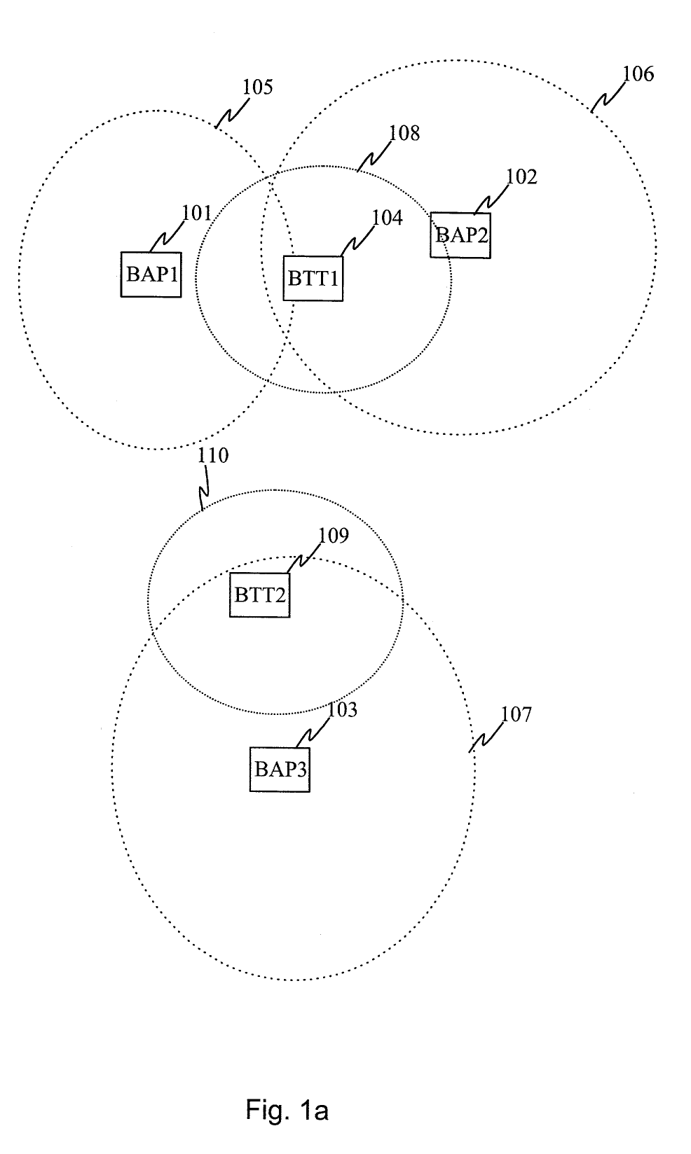

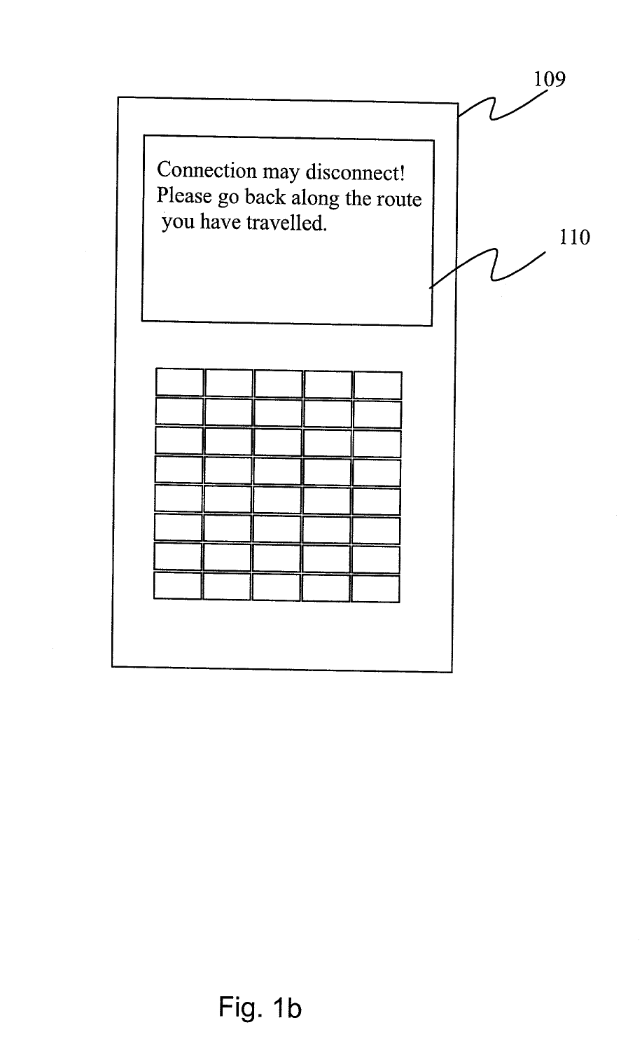

FIG. 1a shows a short-range radio system according to one embodiment of the invention. Operation of the radio system is described from the viewpoint of the Bluetooth system but the use of the invention is not restricted to said Bluetooth system only. The system comprises one or more access points 101 to 103 and one or more short-range terminals 104, 109. Access point 101 serves within range 105, access point 102 serves within range 106 and access point 103 serves within range 107. If the transmission power of the access point (101 to 103) exceeds that of the terminal (104, 109), the terminal (104, 109) is able to receive messages from the access point (101 to 103) beyond the range (108, 110) of the terminal (104, 109). This is an advantageous property, because the terminal (104, 109) may already be so far away that the access point (101 to 103) does not necessarily receive the communication from the terminal (104, 109) properly, but it can be assumed that the terminal (104, 109) receives a warning from the access point (101 to 103) that the connection may be disconnected. This advantageous property is typical in the Bluetooth environment, because the transmission power used in Bluetooth circuits for portable devices, such as terminals, is presumably lower than in Bluetooth circuits integrated in fixed access points. The Bluetooth protocol supports monitoring of the quality of the signal, so it can be directly used for monitoring the extreme limit between the access point (101 to 103) and the terminal (104, 109).

In the following, communication between two different Bluetooth devices 104 and 109 and access points 101 to 103 is described by way of an example. Terminal 109 communicates with access point 103 and terminal 104 communicates with access points 101 and 102.

Bluetooth terminal 109 sends inquiries to its environment within range 110 in order to establish a connection between other Bluetooth terminals or devices and in order to form a pico network with said terminals or devices. Prior to a first contact terminal 109 is in a standby mode, listening to traffic in its area. Access point 103 acts as a host device within range 107, forming a pico network, to which a maximum of seven terminals can be attached. Access point 103 takes care of call establishment to terminals to be attached to the pico network by searching for devices in the vicinity and exchanges data, for instance, on clock-offset and device addresses according to the Bluetooth protocol. Access point 103 transmits a paging message in its environment if the address of the target device is known and an inquiry message if the address of the target device is not known, and when terminal 109 receives said paging message an SPD (Service Discovery Protocol) session begins between said terminals. During the SPD session all necessary information for forming a Bluetooth connection is collected e.g. from terminal 109 to access point 103. The information necessary for connection establishment can comprise e.g. the Bluetooth category of the devices, because Bluetooth devices must be able to identify one another and find out the capabilities and properties of the identified devices. Because Bluetooth technology is well suited for a variety of devices, it cannot be expected that all devices have the same capabilities. Therefore, the devices have been divided into categories, each of which supporting a particular set of properties. In this manner, it is possible to apply software modules suitable for communication depending on which kind of devices intercommunicate. After the necessary data for establishing a Bluetooth connection have been collected, a free radio channel can be allocated for the connection, and terminal 109 can start communication, such as data transmission, with access point 103. The access point may be located e.g. in business premises, where a seller gives information on his products via access point 103 to a possible buyer, i.e. in this case to the user of terminal 109. Access point 103 receives the signal transmitted by terminal 109, and on the basis of the signal strength said access point 103 is able to determine whether the distance of terminal 109 from access point 103 is on the border area of range 110. If the level of the signal transmitted by terminal 109 falls below a predetermined threshold value, access point 103 transmits information to terminal 109 about deterioration of the quality of the connection. The information comprises e.g. an audiovisual message guiding the user, such as a text message to be presented on the display of the terminal and/or a synthesized speech message, which can read as follows “connection may disconnect, please go back along the route you have travelled”, to be advised to the user of terminal 109. Alternatively, the information can comprise a message about the location of the access point in the premises e.g. “connection may disconnect, please go towards leisure department sign”. The message can be shown on the display 110 of terminal 109, for instance, as in FIG. 1b. If access points 101 and 102 are also located in the same business premises in the example of FIG. 1a, the information can then also comprise e.g. the location of said access points 101 and 102, for instance, access point 103 invites the user of terminal 109 to move closer to access point 101 by transmitting to terminal 109 a message “walk towards food department sign and you will have information on our new products”. If the signal falls below the threshold value, a new value can be measured after a short delay before a warning is transmitted, this allows avoiding unnecessary messages that are generated when the terminal moves to possible shadow areas within the range. In the Bluetooth system, the above-mentioned delay can be e.g. one or more time slots (one time slot being 625 microseconds).

When the connection between devices 103 and 109 is terminated, one of the parties transmits an LMP (Link Manager Protocol) detach message, which terminates the connection between the parties. If terminal 109 is already beyond range 110 from access point 103 and cannot thus transmit the LMP detach message to access point 103, said access point 103 can transmit said message to terminal 109 if the quality of the connection does not change within a predetermined threshold value, for instance a given time (e.g. 5 seconds).

In another example terminal 104 moves away from access point 101 towards access point 102, for instance, along a corridor in business premises. Access point 101 detects that a signal transmitted by the terminal is below a predetermined threshold value, whereby access point 101, as in the previous example, can transmit a request to the user of terminal 104 to go back along the route travelled or to inform the user about another access point, such as access point 102 or 103 and to request the user to go towards said access point.

If access points 101 and 102 intercommunicate and ranges 105 and 106 form an area where the user of terminal 104 can move about such that a connection to at least one of access points 101, 102 is maintained, access point 101 is able to inform access point 102 about terminal 104, whereby access point 102 can take over and serve the user of terminal 104 from the point where access point 101 left, or alternatively to serve the user of the terminal with new information. A previous application U.S. Ser. No. 09/803,534 of the Applicant discloses a method and a system, in which a user can move from one access point to another within a short-range radio-frequency network without that the connection is apparently disconnected.

If a plurality of access points communicate with one another, it is also possible to determine, on the basis of the information they receive from terminal 104, the location of said terminal, whereby the network coverage area and the current location of the user of terminal 104 in said network area can be defined more precisely for the user. A previous FI patent 106,655 of the Applicant discloses a method and a system for positioning a transmitter, which can be applied to a short-range rf network. In a network like this it is possible to inform the terminal, by utilizing positioning, when it might be exiting the network area.

While the terminal (104, 109) is communicating with the access point (101 to 103), the access point advantageously tends to act as a host device, so the terminal (104, 109) is advantageously a slave device, thus the terminal cannot search for other connections but the host device, i.e. the access point, has to tell the terminal about possibilities prior to disconnection, and not until the old connection is disconnected, can the terminal receive information from a new access point.

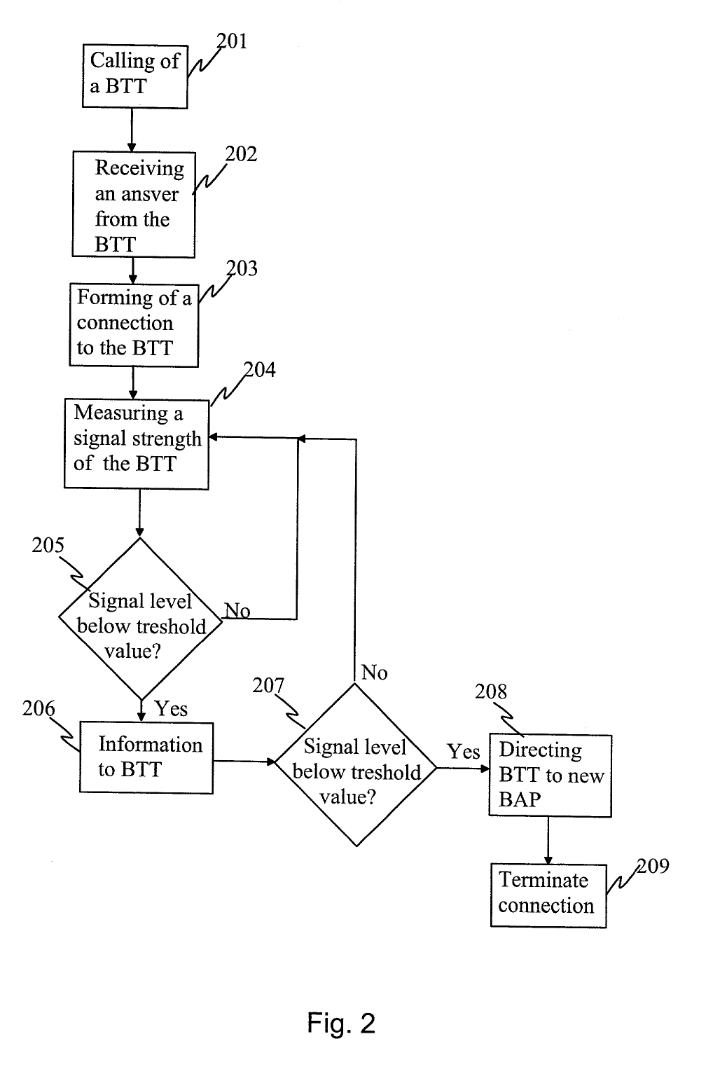

FIG. 2 shows a flow chart of a method according to one embodiment of the invention at an access point. In step 201, the access point transmits a paging message to its environment. In step 202, a reply is received from a terminal. In step 203, a connection is established to the terminal. In step 204, strength of the signal transmitted by the terminal is measured. In step 205, it is examined if the signal level is below a predetermined threshold value. If not, steps 204, 205 are repeated until the signal level is below said threshold value and step 206 is proceeded to. In step 206, information about deterioration of the quality of the connection is transmitted to the terminal. In step 207, it is again examined if the signal level is below said threshold value. If the signal level is below said threshold value, step 208 is proceeded. Alternatively, in step 204 it is possible to have a pause after the first measurement and remeasure the signal level, whereby temporary movement of the terminal into a shadow area, or any other corresponding disturbance caused by signal strength deterioration can be avoided in the measurement result. In step 208, the terminal is informed about the location of a second access point, and in step 209, the connection to the terminal is terminated. The above-described different steps of the method can be implemented e.g. as a computer software product, which comprises computer software means for making said access point implement the steps set forth in said method.

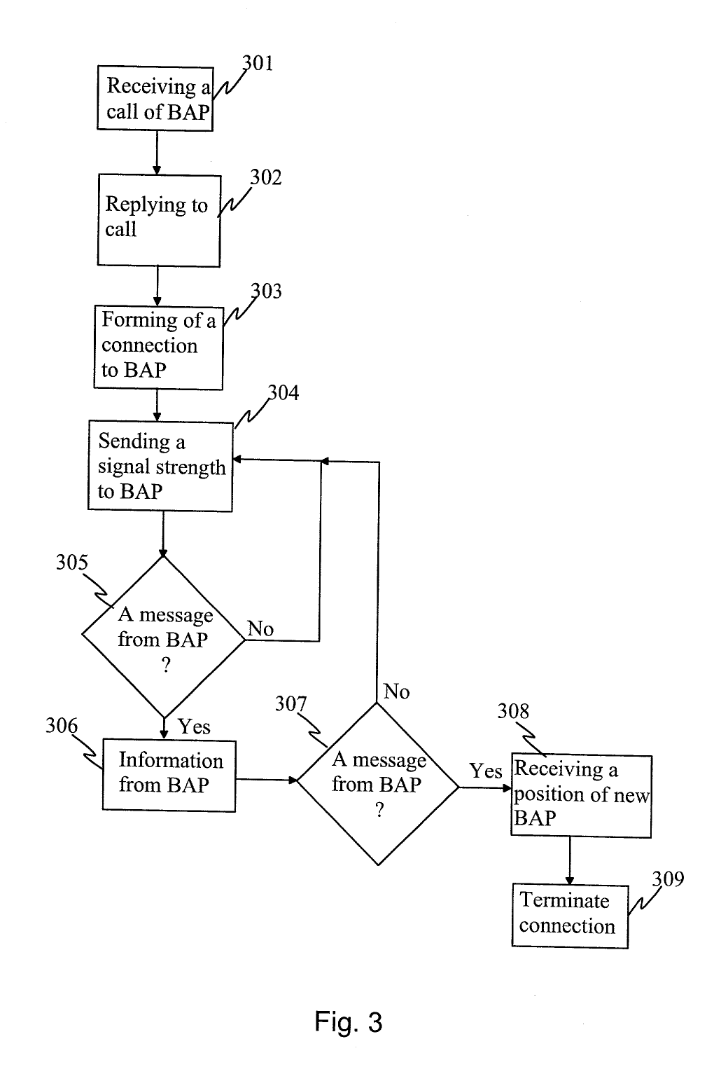

FIG. 3 shows a flow chart of a method according to one embodiment of the invention at a terminal. In step 301, an Inquiry from an access point is received. In step 302, the inquiry from the access point is answered with an Inquiry Response. In step 303, a connection is established to the access point. In step 304, a signal is transmitted to the access point. In step 305, it is examined if the access point has transmitted a message, and if not, steps 304, 305 are repeated until a message (step 306) is received from the access point and said message is forwarded to the user of the device, the message comprising a warning of the quality of the connection being deteriorated. In step 307, it is examined again if a new message is transmitted from the access point, and if not, e.g. in the case that the user of the device has moved closer to the access point and the quality of the connection has improved, step 304 is proceeded. If a message is received in step 307, step 308 is proceeded to and the message is presented to the user of the device, which message may comprise the location of a second access point, for instance. In step 309, the ongoing connection to the access point is terminated. The above-described different steps of the method can be implemented e.g. as a computer software product, which comprises computer software means for making said access point implement the steps set forth in said method.

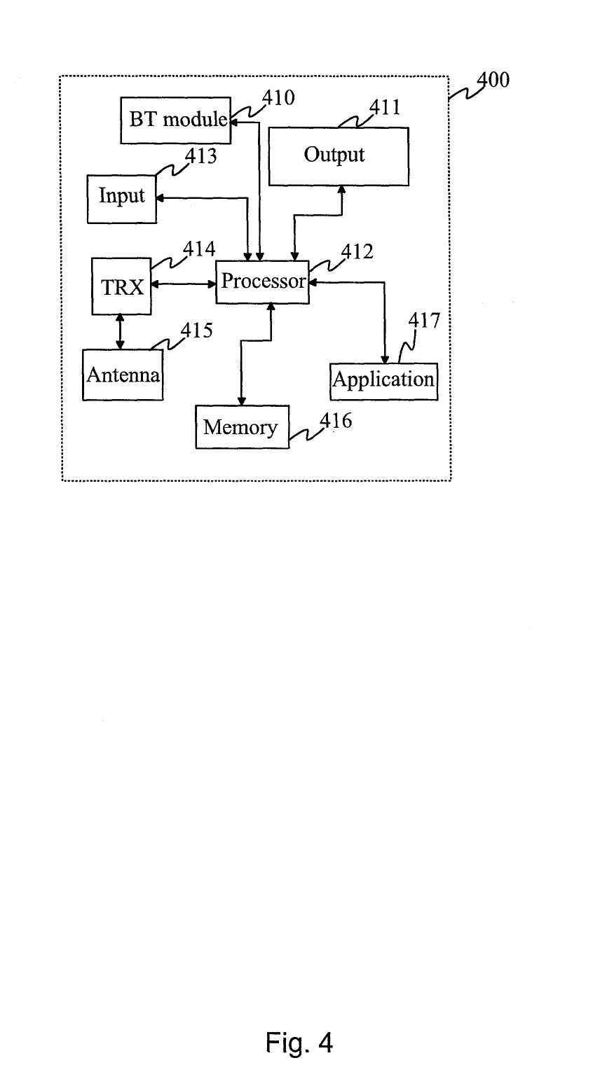

FIG. 4 shows one embodiment of a terminal 400 to be used in a short-range radio system. The terminal comprises means 411, 413 for forming information, which means further comprise e.g. a display and a loudspeaker, by which the user can receive audiovisual information through the terminal, and a keyboard or a touch screen for entering data into the terminal. Terminal 400 may also comprise a processor 412 for executing the operations of the terminal and a memory 416 for storing the received information, for instance, means 412, 414, 415 for receiving information wirelessly, further comprising a Bluetooth module 410, one or more transceivers 414, and one or more antennae 415 for short-range radio communication, such as Bluetooth communication, or for communicating with a mobile network, for instance. In addition, terminal 400 comprises one or more applications 417 for receiving the information, transmitted by the access point, by means of antenna 415 and transceiver 414 into memory 416 of terminal 400 and further for presenting it on the display 411 of terminal 400. Application 417 also comprises computer software means for making said terminal transmit a radio-frequency signal to said access point, computer software means for making said terminal receive information from said access point in response to the transmitted signal, the information comprising an item about a change in the quality of the connection, and being at least one of the following: visual information and speech information. Said information is advantageously such that advises the user about the deterioration of the quality of the connection and it may also comprise a location to be advised to the user, where said quality of the connection will improve.

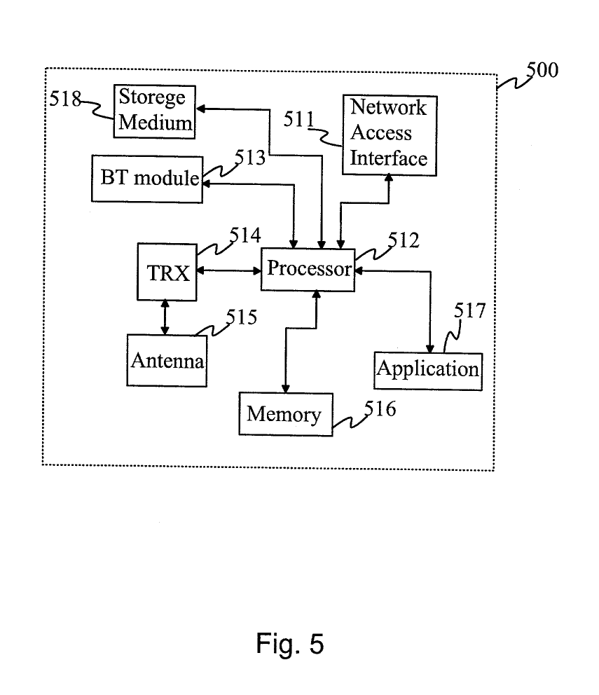

FIG. 5 shows one embodiment of an access point 500 to be used in a short-range radio system. The access point comprises a processor 512 for executing the operations of the terminal and a memory 516 for storing the strength of the received signal transmitted by the terminal, for instance, means 513, 514 and 151 for receiving information, further comprising a Bluetooth module, one or more transceivers 514 and one or more antennae 515 for short-range radio communication, such as Bluetooth communication, or for communicating with a mobile network, for instance. In addition, the terminal may comprise an interface 511 e.g. to a network, such as a mobile local area network or Internet network, a storing means 518 for storing information to be transmitted to the terminal in the access point, one or more applications 517, for instance, for comparing the signal strength of the terminal with a predetermined threshold value or for transmitting a message to the terminal. Application 517 also comprises computer software means for making said access point establish a connection to a short-range terminal (400), computer software means for making said access point receive the signal of said terminal, computer software means for making said access point compare the strength of said signal with a predetermined threshold value and computer software means for making said access point transmit information to the terminal in response to the performed comparison, the information comprising an item about a change in the quality of the connection, and being at least one of the following: visual information and speech information. Said information is advantageously such that advises the user about the deterioration of the quality of the connection and it may also comprise a location to be advised to the user, where said quality of the connection will improve.

The method, the system and the device according to the invention have been illustrated in FIGS. 1a to 5 and in descriptions thereof in the Bluetooth environment. However, the invention is not restricted to the use in the Bluetooth environment only, but it is apparent to a person skilled in the art that it is also possible to use other communication systems.

The present document describes the implementation and embodiments of the invention by means of examples. It is apparent to a person skilled in the art that the invention is not restricted to the details of the above-described embodiments and that the invention can be implemented in a variety of ways without deviating from the characteristics of the invention. The embodiments set forth should be considered illustrative, not restrictive. Thus, the implementations and uses of the invention are only restricted by the attached claims. Thus, various alternative implementations, also equivalent implementations, defined by the claims are within the scope of the invention.

1. A method in an access point for informing a terminal device of a change in the quality of a short-range radio connection between the terminal device and the access point, which method comprises
establishing a short-range radio connection between the terminal device and the access point,
monitoring, by said access point, a strength of a radio-frequency signal transmitted by said terminal device,
comparing, by said access point, the strength of the radio-frequency signal transmitted by said terminal device with a predetermined threshold value, wherein
transmitting a message to the terminal device by said access point if said signal strength is below the predetermined threshold value, the message comprising information on said connection quality change to be presented in said terminal, said information being at least one of the following: visual information and speech information.

2. A method as claimed in claim 1, wherein said information comprises a notification of a change in the quality of the connection.

3. A method as claimed in claim 2, wherein said information also comprises a location, where said connection quality of said terminal device will improve.

4. A method as claimed in claim 3, wherein said location is determined by giving a direction towards said access point.

5. A method as claimed in claim 3, wherein said location is determined by giving a direction towards a second access point.

6. A method as claimed in claim 1, wherein in the method, prior to the transmission of said information, the access point awaits for a predetermined time after the comparison indicates signal strength below the threshold value and the signal strength is measured again.

7. A method as claimed in claim 1, wherein said short-range connection is a Bluetooth connection.

8. A system for informing of a change in the quality of a short-range radio-frequency connection between a terminal device and an access point, the system comprising at least one terminal device and at least one access point, said terminal device capable of communicating on the short-range radio connection with said access point, the system comprising
connection establishment means for establishing a connection between said terminal device and said access point,
monitoring means for monitoring a strength of a signal transmitted by said terminal device,
comparison means for comparing the strength of the radio-frequency signal transmitted by said terminal device with a predetermined threshold value, wherein the system further comprises
formation means for forming information to the terminal device in response to the detected change in the quality of the connection,
transmission means for transmitting a message to said terminal device if said signal strength is below the predetermined threshold value, the message comprising information on the change in the quality of said connection to be presented in said terminal device, said information being at least one of the following: visual information and speech information.

9. A system as claimed in claim 8, wherein said formation means are implemented to form information, which comprises a location, where the quality of the connection will improve.

10. An electronic device, capable of communicating on a short-range communication system, the device comprising connection establishment means for establishing a connection with a short-range terminal device, wherein the device further comprises
reception means for receiving a signal strength of the connection established with said terminal device,
comparison means for comparing the signal strength with a predetermined threshold value and
transmission means for transmitting information to the terminal device in response to the performed comparison, the information comprising a notification of a change in the quality of the connection, said notification being at least one of the following: visual information and speech information.

11. An electronic device as claimed in claim 10, wherein said transmission means are implemented to transmit said information about the change in the quality of said connection to be presented in said terminal if said signal strength is below said threshold value.

12. An electronic device as claimed in claim 10, wherein said electronic device is a Bluetooth access point.

13. A short-range terminal, capable of communicating on a short-range communication system, the terminal comprising means for establishing a connection with a short-range access point, wherein the device further comprises
transmission means for transmitting a signal to said access point,
reception means for receiving information from said access point in response to the transmitted signal, the information comprising a notification of a change in the quality of the connection, said notification being at least one of the following: visual information and speech information.

14. A terminal as claimed in claim 13, wherein said reception means are implemented to receive the information, which comprises a location, where the quality of the connection of said terminal will improve.

15. A terminal as claimed in claim 14, wherein said terminal is a Bluetooth terminal.

16. A computer software product for a short-range rf access point said access point is capable of communicating on a short-range communication network with at least one short-range terminal and which computer software product comprises computer software means for establishing a connection from said access point to the short-range terminal, wherein the computer software product comprises
computer software means for making said access point receiving a signal from said terminal,
computer software means for making said access point comparing the strength of the signal with a predetermined threshold value, and
computer software means for making said access point transmitting information to said terminal in response to the preformed comparison, the information comprising a notification of a change in the quality of the connection, said notification being at least one of the following: visual information and speech information.

17. A computer software product for a short-range terminal device (400), which terminal device is able to communicate in a short-range communication network with at least one short-range rf access point, and which computer software product comprises computer software means for making said terminal device establish a connection with the short-range rf access point, wherein the computer software product comprises
computer software means for making said terminal transmitting a radio-frequency signal to said access point,
computer software means for making said terminal receiving information from said access point in response to the transmitted signal, the information comprising about a notification of a change in the quality of the connection, said notification being at least one of the following: visual information and speech information.
